(19) United States
(12) Patent Application Publication
(10) Pub. No.: US 2023/0325783 A1
(43) Pub. Date: Oct. 12, 2023

(54) SENTIMENT ANALYSIS BASED EVENT SCHEDULING

(71) Applicant: International Business Machines Corporation, Armonk, NY (US)

(72) Inventors: Uri Kartoun, Cambridge, MA (US); Fang Lu, Billerica, MA (US); Adam Perer, Pittsburgh, PA (US)

(21) Appl. No.: 16/448,326

(22) Filed: Jun. 21, 2019

(51) Int. Cl. G06Q 10/1093

(52) U.S. Cl. CPC G06Q 10/1095

(57) ABSTRACT

A sentiment analysis scheduling method, system, and computer program product include analyzing prior sentiments based on past events, building a personalized data model with a categorized event type and a sentiment outcome based on the prior sentiments, analyzing an upcoming event content and predicting a potential sentiment outcome for the upcoming event based on the personalized data model, and rearranging an order of future events to achieve the predicted potential sentiment outcome for the upcoming event.

### BACKGROUND

The present invention relates generally to a sentiment analysis scheduling method, and more particularly, but not by way of limitation, to a system, method, and computer program product for intelligently suggesting an event time arrangement and order for one or more users, in order to increase the likelihood for an upcoming event to be successful. This could be achieved by identifying alternative time slots for the event with the potential to maximize positive sentiment influence associated with different factors (i.e., order events in a different sequence to potentially achieve an optimal sentiment outcome for the user and all other associated participants, etc.).

A meeting/event is presumably more effective/successful when the attendees are more relaxed, feel positive, and patient. However, people react to situations differently, may get emotional towards different situations, may react differently in different times/days of the week, and may react differently during different hours of the day (e.g., early Monday morning vs. Friday afternoon, a day before a major holiday, etc.).

Conventional event arrangement and meeting scheduling products use the attendees' free/busy time data and the location of the event to make a decision. However, conventional techniques do not consider the previous sentiment and productivity outcome data as a factor to identify a potentially more beneficial arrangement of one or more planned events.

### SUMMARY

In an exemplary embodiment, the present invention provides a computer-implemented sentiment analysis scheduling method, the method including analyzing a prior sentiment based on past events, building a personalized data model with a categorized event type and a sentiment outcome based on the prior sentiments, analyzing an upcoming event content and predicting a potential sentiment outcome for the upcoming event based on the personalized data model, and rearranging an order of future one or more events to achieve the predicted potential sentiment outcome for the future one or more events.

One or more other exemplary embodiments include a computer program product and a system, based on the method described above. In another embodiment the invention method could be integrated in an existing software product, such as a calendar management system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily show a high-level flow chart for a sentiment analysis scheduling method 100 according to an embodiment of the present invention;

FIG. 2 exemplarily depicts an example of event scheduling according to an embodiment of the present invention;

FIG. 3 depicts a cloud-computing node 10 according to an embodiment of the present invention;

FIG. 4 depicts a cloud-computing environment 50 according to an embodiment of the present invention; and

FIG. 5 depicts abstraction model layers according to an embodiment of the present invention.

### DETAILED DESCRIPTION

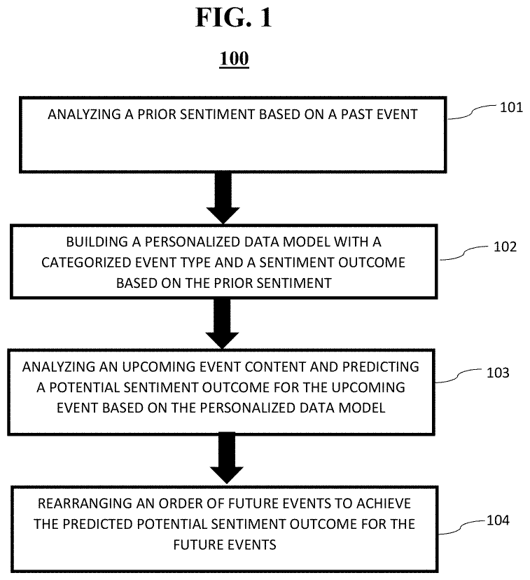

The invention will now be described with reference to FIGS. 1-5, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a sentiment analysis scheduling method 100 according to the present invention can include various steps to predict (and propose) an optimal schedule to maximize the likelihood for a successful event based on a sentiment towards the event.

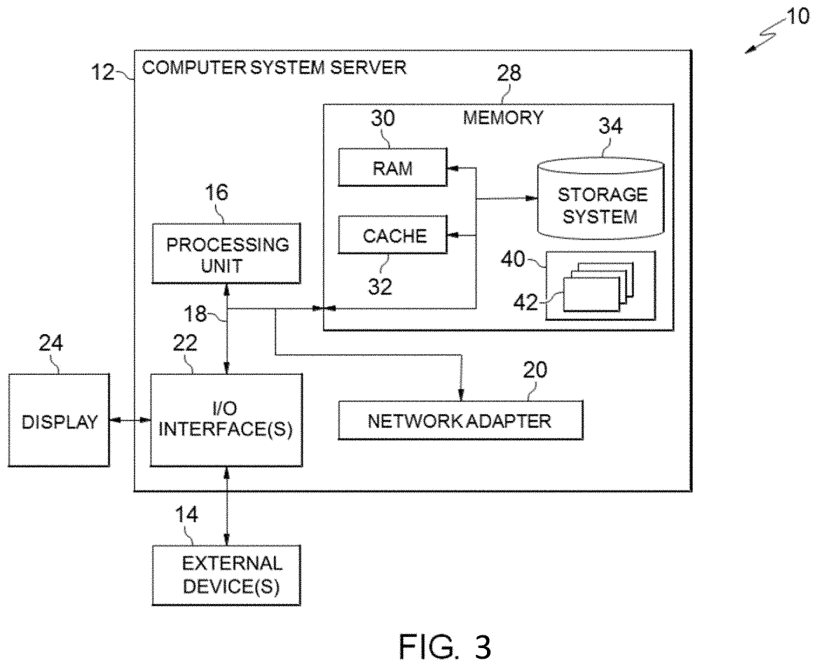

By way of introduction of the example depicted in FIG. 3, one or more computers of a computer system 12 according to an embodiment of the present invention can include a memory 28 having instructions stored in a storage system to perform the steps of FIG. 1.

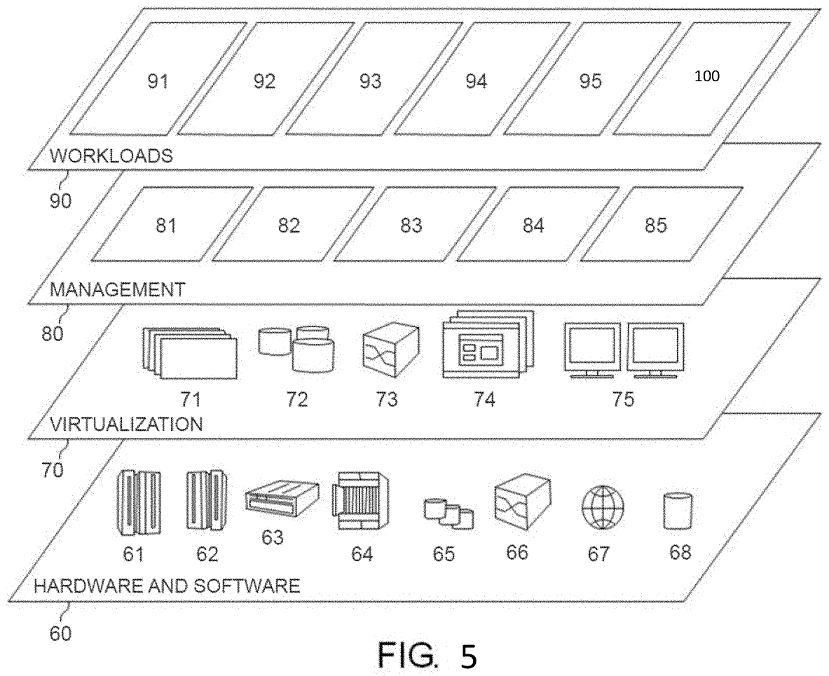

Although one or more embodiments may be implemented in a cloud environment 50 (e.g., FIG. 5), it is nonetheless understood that the present invention can be implemented outside of the cloud environment.

It is noted that “attendee” and “user” are used interchangeably herein.

With reference generally to FIG. 1, in step 101, a prior sentiment is analyzed based on a past event.

In step 102, a personalized data model is built with a categorized event type and a sentiment outcome based on the prior sentiment.

In step 103, an upcoming event content is analyzed and a potential sentiment outcome is predicted for the upcoming event based on the personalized data model.

In step 104, an order of future events is rearranged to achieve the predicted potential sentiment outcome for the future events.

Indeed, with at least steps 101-104, the invention can intelligently suggest the event time arrangement and order for the one or more users in order to increase the likelihood for the event to be successful by identifying alternative time slots with the potential to be associated with positive sentiment influence associated with different factors. The factors can include, for example, any other events that will happen prior to the scheduled event that might contribute varied sentiment due to its content (e.g., a prior intensive other meeting might affect decisions, etc.), the local sunrise/sunset information at the attendee's time zone that might trigger varied sentiment of the attendees (e.g., an attendee might feel under pressure when it is almost 4 p.m. and thinking of the expected traffic jams on the way home, etc.), and the user's scheduled meal time that might contribute to a possible sentiment to the attendees (e.g., people tend to be more relaxed after lunch, etc.). Thereby, the invention may greatly improve peoples' productivity and the best outcome from each event by arranging the events in the logical order that works the best for the event attendees' sentiment.

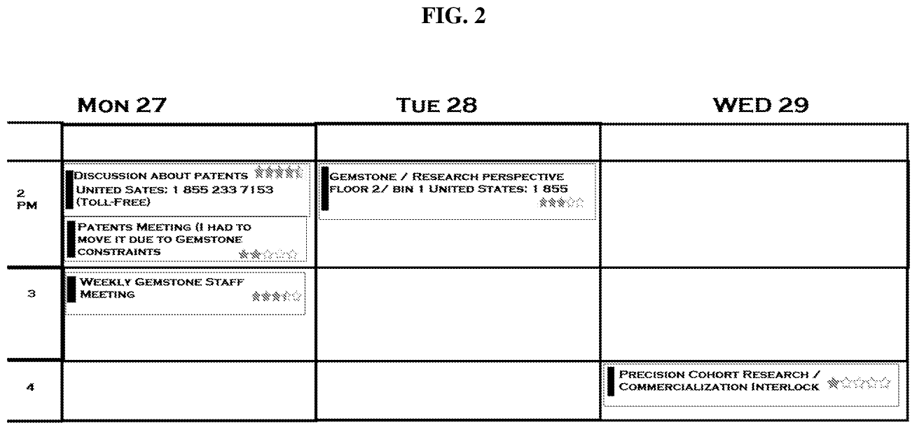

With reference generally to FIGS. 1-2, optionally, the invention may be enhanced with additional capabilities that incorporate sensing technologies. In such an embodiment the invention continuously monitors the user's sentiment from his/her day-to-day life by collecting vital sign data (e.g., heartbeat, breathing pattern, body temperature, etc.) and other input data such as the comments the user makes through email/instant messaging/phone message/phone call/posts on the social networking website.

The invention analyzes how the user reacts to different types of events and tags the events with different types of sentiment tags such as “happy,” “sad,” “angry,” “calm,” etc.

Then, the invention may analyze how the user reacts at different times of the day to various factors such as how the daylight outside the room (or the lack thereof) would impact the user's sentiment, analyze how the user sentiment pattern before the user consumes a meal and after the user consumes a meal, etc.

Based on incorporating personal sensing measurements and applying to the measurements machine learning techniques, the invention categorizes the event type/event content/event attendees/daylight condition of the local time zone/before-meal vs. after-meal factors based on the sentiment tags.

Then, the invention builds a personalized data model for the user that correlates with these exemplary factors and sentiment tags. Also, the invention analyzes any upcoming events that will be scheduled for the user.

In one embodiment, the invention takes into consideration the daylight condition of the attendee's local time zone. If the user is happier during the day than at the night (or during specific time windows during the day), then the invention marks the daytime slot with a “Yes” score (or in a more granular form such as in the rank of 1=most undesirable to 10=most desirable). The invention further takes into consideration the time that the user may have his/her meal(s). If the user is happier after he/she has a meal then the invention marks after meal time slot with a higher score.

The invention further analyzes whether the event will happen before or after the new event would potentially reduce the effectiveness of the outcome of this new event. If any of the events that will happen before this new event would contribute to a positive sentiment to the user, then the invention will mark a “Yes” score with the previous event.

In one embodiment, the invention analyzes the intended goal of the new event and the importance and impacts of the new event.

In one embodiment, the invention allows all users who use an on-line calendar to rank any meeting that occurred in the past. A rank for a meeting could either be “Yes” (indicating a positive experience), or “No” (indicating a negative experience). A rank could also have a range, for example, 1 to 5 in which 5 represents the highest level of satisfaction and 1 represents lack of satisfaction from the meeting. A user may also be triggered to rank a meeting he/she participated at that has just finished, similarly either in a binary manner (Yes/No) or in a continuous manner (a score). By ranking many past meetings by many users, a database of meetings and their labels is being formed. Once a label is associated with each meeting, additional characteristics for each meeting are being extracted. Such characteristics include, for example, number of participants, time of the day, length, proximity to lunch/breakfast, proximity to major events, to major holidays, to major news events associated with the participants' companies, etc. Once both data elements, i.e., labels and variables are extracted, a supervised learning machine learning could be used to create a prediction model. Such an algorithm, for example, logistic regression, support vector machines, or any other commonly used supervised learning algorithm could be used to generate out of the labels and their associated variables, a prediction model. A prediction model is a data structure that represents the level of association between a set of variables and a label. A prediction model could be used to be queried with an array of variables, and then calculate a probability for an anticipated label. Given a set of a future meeting characteristics, the prediction model can determine a low level of success for that meeting, and thus propose alternative time slots with a higher probability to be successful.

In one exemplary use case scenario, “John” (i.e., the attendee) needs to present a customer demonstration this afternoon. This customer demonstration is very important, as the customer will make a decision regarding signing a major purchase order mainly based on the features that are presented to them during this meeting. John needs to present to the customer. The invention analyzes the meeting agenda, and meeting attendees' information. The invention analyses the social relationship and working relationship among these meeting attendees. The invention scans John's calendar to see what events will happen before or after this important customer demo.

Based on this, the invention recognizes that John needs to attend a single-sign-on software architecture design review meeting just before this customer demo meeting. The invention retrieves the sentiment pattern data that was collected/analyzed for this type of single-sign-on software architecture design review meeting that John has attended. The invention assesses that meetings with a similar content and timing received low scores. The invention suggests the customer demo needs to be scheduled before the single-sign-on software architecture design review meeting. The invention also suggests scheduling the customer demo meeting to 1:30 pm as similar previous meetings were identified to be more successful; this is likely due the time slot in which attendees may be more relaxed after having a satisfying meal. It should be noted that not all meetings tend to be more successful after lunch, but only portion of them; our invention is capable of identifying which meetings scheduled after lunch time are likely to be more successful, and which meetings will not benefit from scheduling in such a time slot.

Thereby, the invention ensures that John enters the customer demo meeting in a calm and positive/upbeat mood. Thus, the invention can identify time slots that have a sentiment that is potentially associated with an increased likelihood for a successful meeting.

With reference to FIG. 2, the invention allows a user to provide a ranking for previous meetings in their calendar. A data-mining module takes these rankings into account. A meeting with a high grade might be associated with a “success” and correlated with other factors that may predict another similar successful meeting. It is noted that a “successful meeting” is judged subjectively to each user. As shown in FIG. 2, the user can provide a rating (e.g., one to five stars rating with five stars being the highest). The invention learns from these ratings and creates a feedback loop to modify the personalized data model according to the user ratings.

For example, uses the time in which a user logs into the computer for the first time that day (or in a more advanced scenario vital sign data captured by using a wearable device) to estimate when he/she woke up today, and ensures that the meeting is scheduled within a reasonable number of hours since he/she woke up. The invention takes into consideration enough time for small breaks between meetings if there are many consecutive meetings (e.g., bathroom breaks, coffee refills, etc.). The invention also may consider a physical location of an event. The invention uses the attendees' location (e.g., via a global position service [GPS]) and ensures that there is sufficient time to travel to the meeting from the current location, given that the meeting is identified as an in-person meeting (as opposed to a remote meeting in which there is no importance to physical locations of the attendees). If no alternative open time slots are found for all attendees, and the event is at a high priority, the invention analyzes all attendees' calendars and tries to automatically reschedule their low-priority conflicting events so that a common time could be found for all. Along with a scheduled location, the invention may also consider forecasted weather, the day of the week (i.e., Monday or Friday are less favorable than Thursday), holidays, sports events, music events, election-related events, how many meetings each person has per day, proximity to end of month/year, etc. The invention can take also into account incidences reported in the news, such as lays off either at the hosting company or at the attendees' company, or a significant drop in the stock value of one or more of the associated companies. Such incidences may affect all attendees, and the invention, may suggest scheduling an important meeting, for instance, 4 weeks, after a negative incidence is reported. Positive reported incidences may also be considered (such as an improved revenue or announcing on the availability of a new revolutionary technology).

Thereby, the invention can schedule flexible meetings to achieve the best possible outcome for one or more meetings.

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 3, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 3, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

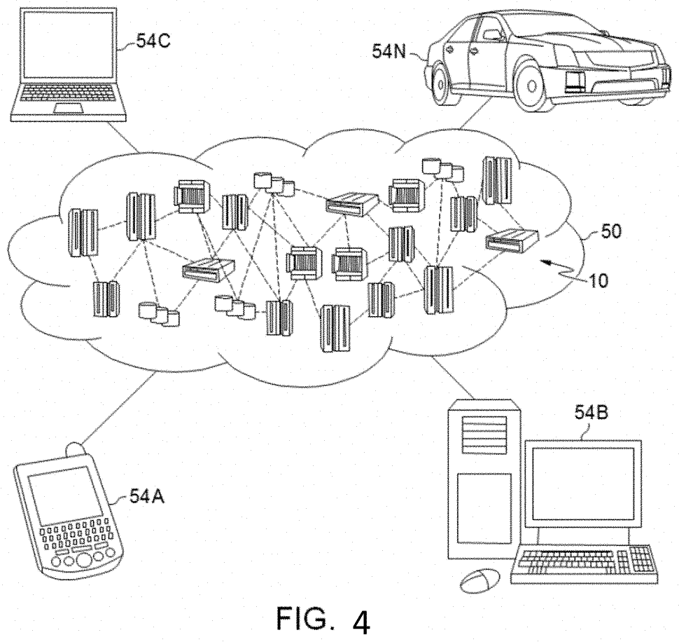

Referring now to FIG. 4, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 4 are intended to be illustrative only and that computing nodes 10 and cloud computing environment 50 can communicate with any type of computerized circuit over any type of network and/or network addressable connection (e.g., using a web browser).

Referring now to FIG. 5, an exemplary set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and sentiment analysis scheduling method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented sentiment analysis scheduling method, the method comprising:
analyzing prior sentiments of an attendee based on past events;
building a personalized data model with a categorized event type and a sentiment outcome based on the prior sentiments;
analyzing an upcoming event content and predicting a potential sentiment outcome for the upcoming event based on the personalized data model; and
rearranging an order of future events to achieve the predicted potential sentiment outcome for the future one or more events.

2. The method of claim 1, wherein a first data file is created based on a result of the analyzing of the upcoming event, and
wherein the rearranging uses the first data file as an input to create the order of future events.

3. The method of claim 1, wherein the rearranging outputs the order of the future events as a second data file to a scheduling system to rearrange a current schedule of a user in the scheduling system.

4. The method of claim 1, wherein the building builds the personalized data model by factoring in at least one of:
an other event that happens prior to the scheduled event;
a weather at the location of the attendee;
local sunrise/sunset information at a time zone of the attendee; and
a scheduled meal time of the attendee.

5. The method of claim 1, wherein the building builds the personalized data model by factoring each of:
an other event that happens prior to the scheduled event;
local sunrise/sunset information at a time zone of the attendee; and
a scheduled meal time of the attendee.

6. The method of claim 1, wherein the attendee is queried for a feedback rating for the rearranged order of the future events, and
wherein the personalized data model is updated based on the feedback rating.

7. The method of claim 1, embodied in a cloud-computing environment.

8. A computer program product for sentiment analysis scheduling, the computer program product comprising a computer-readable storage medium having program instructions embodied therewith, the program instructions executable by a computer to cause the computer to perform:
analyzing a prior sentiment based on past events;
building a personalized data model with a categorized event type and a sentiment outcome based on the prior sentiment;
analyzing an upcoming event content and predicting a potential sentiment outcome for the upcoming event based on the personalized data model; and
rearranging an order of future events to achieve the predicted potential sentiment outcome for the future events.

9. The computer program product of claim 8, wherein a first data file is created based on a result of the analyzing of the upcoming event, and
wherein the rearranging uses the first data file as an input to create the order of future events.

10. The computer program product of claim 8, wherein the rearranging outputs the order of the future events as a second data file to a scheduling system to rearrange a current schedule of a user in the scheduling system.

11. The computer program product of claim 8, wherein the building builds the personalized data model by factoring in at least one of:
an other event that happens prior to the scheduled event;
a weather at the location of the attendee;
local sunrise/sunset information at a time zone of the attendee; and
a scheduled meal time of the attendee.

12. The computer program product of claim 8, wherein the building builds the personalized data model by factoring each of:
an other event that happens prior to the scheduled event;
local sunrise/sunset information at a time zone of the attendee; and
a scheduled meal time of the attendee.

13. The computer program product of claim 8, wherein the attendee is queried for a feedback rating for the rearranged order of the future events, and
wherein the personalized data model is updated based on the feedback rating.

14. A sentiment analysis scheduling system, the system comprising:
a processor; and
a memory, the memory storing instructions to cause the processor to perform:
analyzing a prior sentiment based on past events;
building a personalized data model with a categorized event type and a sentiment outcome based on the prior sentiment;
analyzing an upcoming event content and predicting a potential sentiment outcome for the upcoming event based on the personalized data model; and
rearranging an order of future events to achieve the predicted potential sentiment outcome for the future events.

15. The system of claim 14, wherein a first data file is created based on a result of the analyzing of the upcoming event, and
wherein the rearranging uses the first data file as an input to create the order of future events.

16. The system of claim 14, wherein the rearranging outputs the order of the future events as a second data file to a scheduling system to rearrange a current schedule of a user in the scheduling system.

17. The system of claim 14, wherein the building builds the personalized data model by factoring in at least one of:
an other event that happens prior to the scheduled event;
a weather at the location of the attendee;
local sunrise/sunset information at a time zone of the attendee; and
a scheduled meal time of the attendee.

18. The system of claim 14, wherein the building builds the personalized data model by factoring each of:
an other event that happens prior to the scheduled event;
local sunrise/sunset information at a time zone of the attendee; and
a scheduled meal time of the attendee.

19. The system of claim 14, wherein the attendee is queried for a feedback rating for the rearranged order of the future events, and
wherein the personalized data model is updated based on the feedback rating.

20. The system of claim 14, embodied in a cloud-computing environment.
